(19) United States
(12) Patent Application Publication
(10) Pub. No.: US 2003/0046040 A1
(43) Pub. Date: Mar. 6, 2003

(54) Method and system for architectural space programming for a facility

(76) Inventor: Hector Alejandro Patrucco, West Hills, CA (US)

Correspondence Address: SAWYER LAW GROUP LLP, P.O. Box 51418, Palo Alto, CA, 94303, US

(21) Appl. No.: 09/944,747

(22) Filed: Aug. 31, 2001

(51) Int. Cl. G06F 17/50

(52) U.S. Cl. 703/1

(57) ABSTRACT

A method and system for architectural space programming for a facility is disclosed. In the method and system, the facility includes a plurality of departments. The method and system comprises entering project data related to the facility and to the departments, and then calculating an architectural space programming plan based on the project data.

Through the aspects of the present invention, the user need only enter data related to the project. While advantageous, the user is not required to have specific knowledge of building design, standards or codes. The method and system according to the present invention automatically processes the project data and performs complex mathematical calculations needed to derive an architectural space program. Because the process is interactive, the user can change the project parameters and evaluate alternate schemes easily and quickly. Thus, an automated tool that dramatically decreases the amount of time to calculate a building's geometry and cost is provided.

### FIELD OF THE INVENTION

The present invention relates to building design and construction, and more particularly to a system and method for architecturally space programming a facility.

### BACKGROUND OF THE INVENTION

The process of designing a building or facility is a complicated, time consuming and expensive endeavor. It is an iterative process, where the design can change continuously depending on client needs and/or technological developments. Prior to commencing this arduous process, a designer can collect valuable building information through architectural space programming.

Architectural space programming provides a detailed tally of the space and cost of the facility prior to commencing design and planning activities. In architectural space programming, a proposed facility is analyzed in light of its function, workload and utilization, as well as in light of building standards and codes. With this information, the designer or builder can evaluate the feasibility of a project before expending further costs associated with designing the facility.

Generally, architectural space programming is performed manually with the aid of a calculator or computerized spreadsheet application by a trained professional. Thus, laypersons are generally not qualified to space program because they are not familiar with the intricacies of building a particular type of facility. Moreover, if the facility is a highly specialized building, such as a health care facility, these calculations can become extremely complicated, thereby limiting the builder's ability to explore different scenarios based on various parameters expeditiously.

Accordingly, what is needed is a system and method for architectural space programming that is automated and expeditious. The method and system should be user friendly, such that a user having little or no knowledge of building codes and standards can perform architectural space programming. The method and system should also be extensible to accommodate changes in building standards and codes. The present invention addresses such needs.

### SUMMARY OF THE INVENTION

A method and system for architectural space programming for a facility is disclosed. In the method and system, the facility includes a plurality of departments. The method and system comprises entering project data related to the facility and to the departments, and then calculating an architectural space program based on the project data.

Through the aspects of the present invention, the user need only enter data related to the project. While advantageous, the user is not required to have specific knowledge of building design, standards or codes. The method and system according to the present invention automatically processes the project data and performs complex mathematical calculations needed to derive architectural space programming parameters. Because the process is interactive, the user can change the project parameters and evaluate alternate schemes easily and quickly. Thus, an automated tool that dramatically decreases the amount of time to calculate a building's geometry and cost is provided. The present invention also offers the following benefits:

Reduced project development time and costs

User can validate data by himself or herself, at his or her leisure

User and/or clients can consider and compare schemes to make an educated value-judgment for the best project solution

Permits planning based on future growth

Being web based, the present invention is easily accessible.

### BRIEF DESCRIPTION OF THE DRAWINGS

FIG. 1 is a block diagram depicting an environment that may be used with the present invention.

FIG. 2 illustrates a control panel screen in accordance with a preferred embodiment of the present invention.

FIG. 3 illustrates a window for selecting a department in accordance with a preferred embodiment of the present invention.

FIG. 4 is a workload screen in accordance with a preferred embodiment of the present invention.

FIG. 5 is a room list screen in accordance with the preferred embodiment of the present invention.

FIG. 6 is an overview screen in accordance with an embodiment of the present invention.

FIG. 7 illustrates a flowchart of a process for architectural space programming in accordance to a preferred embodiment of the present invention.

### DETAILED DESCRIPTION

The present invention relates to building design and construction, and more particularly to a system and method for architectural space programming a facility. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

In a method and system in accordance with the present invention, architectural space programming of a project is performed automatically based on the type of facility the user is building and project data provided by the user. The project data is specific to the facility type and includes information about each department or service in the facility. Such information relates to the facility's projected use and workload. Because the user is generally a person with knowledge of the proposed facility and its utilization factors, this data should be readily available to the user.

A method and system in accordance with the present invention then incorporates into its calculations facility specific parameters, such as types of equipment utilized in such a facility and their corresponding spatial requirements and building standards and codes for the facility, and the specific project data, such as the occupancy or number of people using the facility, and the workload or activity that takes place in each room, as well as the time taken to perform the activity. Based on these calculations, a department-by-department breakdown of architectural space programming, including the number and types of rooms in each department and their respective dimensions is provided. In addition, a method and system of the present invention will calculate the associated construction costs.

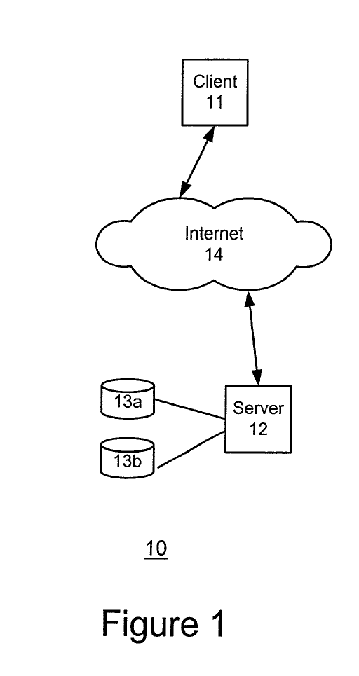

To better illustrate features of the present invention, please refer to the following discussion related to the architectural space programming of a healthcare facility, and the accompanying figures. FIG. 1 is a block diagram depicting an environment 10 that may be used with the present invention. A client computer or server 11 is coupled to a server 12, which may comprise a database 13a, 13b. The client computer 11 and the server 12 are coupled to one another by various networks (not shown), including LANs, WANs, SNA networks, and the Internet. In a preferred embodiment, the method and system of the present invention is implemented as a software application running on the server 12, which a user accesses via the client computer 11 via the Internet 14. While the preferred embodiment of the present invention is described as an online application accessed via the Internet 14, one of ordinary skill in the art would readily recognize that the present invention could also be implemented on a computer readable medium executed on the client computer 11.

When the application is accessed, either directly or via the Internet 14, the user can select a type of facility, in this case a healthcare facility. In response, a control panel 50 corresponding to the facility type, such as that shown in FIG. 1, is presented to the user. The control panel 50 includes a plurality of fields, into which the user enters data specific to the facility, e.g., its capacity and its occupancy. From this information, a grand total area will be calculated for the facility.

Thus, in the healthcare facility control panel 50, the user can enter a number of Patient Days 52 and an Occupancy Rate 53 and the application will automatically calculate the number of Hospital Beds 54. In the alternative, the user can enter directly the number of Hospital Beds 54 in the appropriate field. Based on this information, as well as building standards and codes for healthcare facilities, the Hospital Grand Total Area 56 will be calculated. Please keep in mind that for different facility types, the user will probably be asked to enter different types of information to determine the grand total area for the facility.

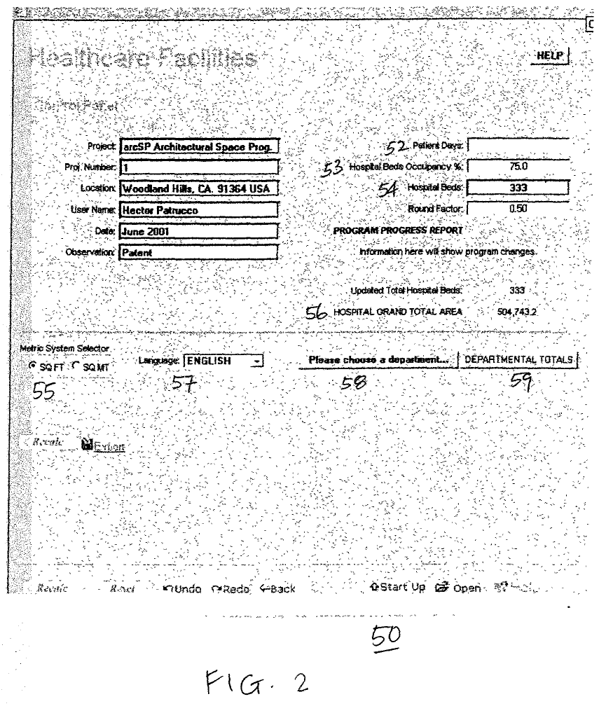

Referring back to FIG. 2, the application offers a pull down menu of languages 57 and a choice of measurement units 55, e.g. square feet or square meters. Thus, individuals understanding a variety of languages can utilize the present invention.

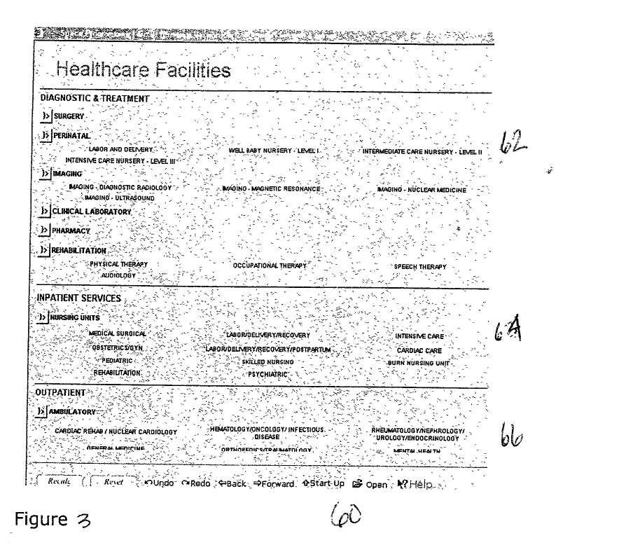

Once the user has completed entering the facility data into the control panel 50, the user selects a department in the facility by clicking on the Please Choose a Department button 58. In the preferred embodiment of the present invention, a list of departments from which the user can choose is presented, as shown in FIG. 3. As is seen, individual departments are organized into broad categories, such as Diagnostic & Treatment 62, Inpatient Services 64, and Outpatient 66. The user can choose a department in any order, one at a time. The user can move back and forth between departments without restriction. The method and system of the present invention will recalculate and adjust values as the user enters new data and/or modifies existing data. When the user selects a department by clicking on the button corresponding to the selected department, a Workload Screen for that department is generated.

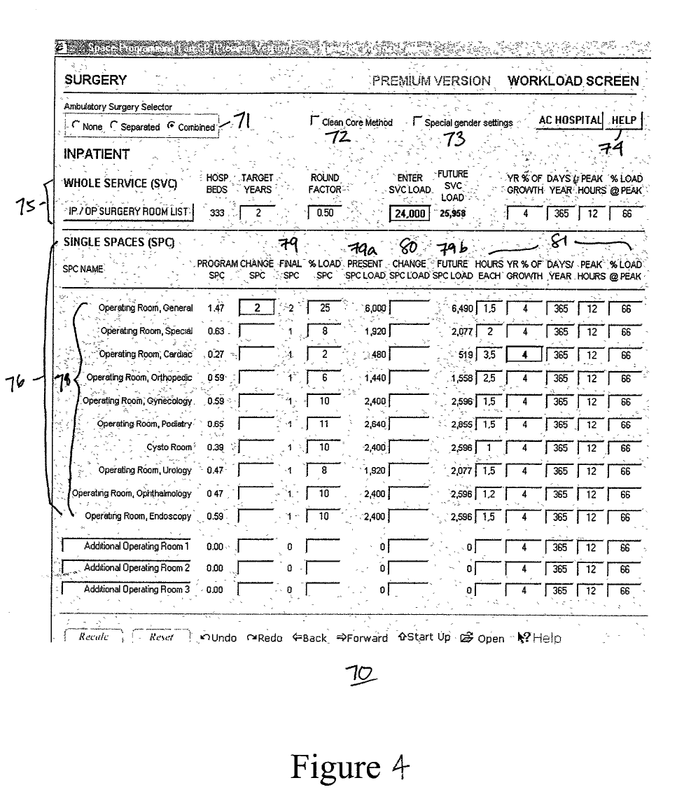

FIG. 4 is an example of a Workload Screen 70 for a Surgery department. In the preferred embodiment of the present invention, the Workload Screen 70 is utilized to calculate the number of rooms that should make up the department. In order to accomplish this, the user is prompted to enter department data pertaining to workload and utilization factors of the department. As is seen, the user is offered options to calculate “Surgery” as an inpatient, outpatient, or combined service 71. The user is also offered working parameters, such as whether the department should be designed according to a Clean Core Method 72 and/or Special Gender Settings 73. If the user is unfamiliar with such terms, the user can utilize a department help menu 74, which provides a detailed explanation of the department's workload screen 70 and a step-by-step instruction for entering the appropriate data.

The Workload Screen 70 includes two sections, a Whole Service Section 75 and a Single Spaces Section 76. In the Whole Service Section 75, the user enters Service Load data 77 for the department as a whole, as well as other workload information. The Service Load is the number of annual surgical procedures performed in the department. Projected (future) service loads are calculated based on an anticipated percentage annual growth, the number of peak hours per day, and the percentage of the load during the peak hours. This workload data is then used to calculate the information in the Single Spaces Section 76.

The Single Spaces Section 76 provides a more refined view of the department and includes a listing of individual workload-driven spaces 78 in the department. As is shown, the number of rooms for each type of room has been calculated, and appears in the Final SPC column 79. In addition, the number of procedures for each type of room and the future load have been calculated at columns 79a and 79b, respectively. The user can refine further the calculation by entering workload data specific to each type of room. For example, the user can enter the number of procedures that will be performed in a particular type of room in the Change SPC Load field 80, and then adjust the utilization factors 81 for each space.

Accordingly, a method and system according to the present invention allows the user to review the Whole Service calculations and/or fine-tune them to match the actual workload for each of the rooms in the department. At any time, the user can change values, e.g. service loads or load percentages for each space, and the present invention will recalculate the department size and cost. Thus, the user can monitor how the department grows or shrinks with specific changes in workload data.

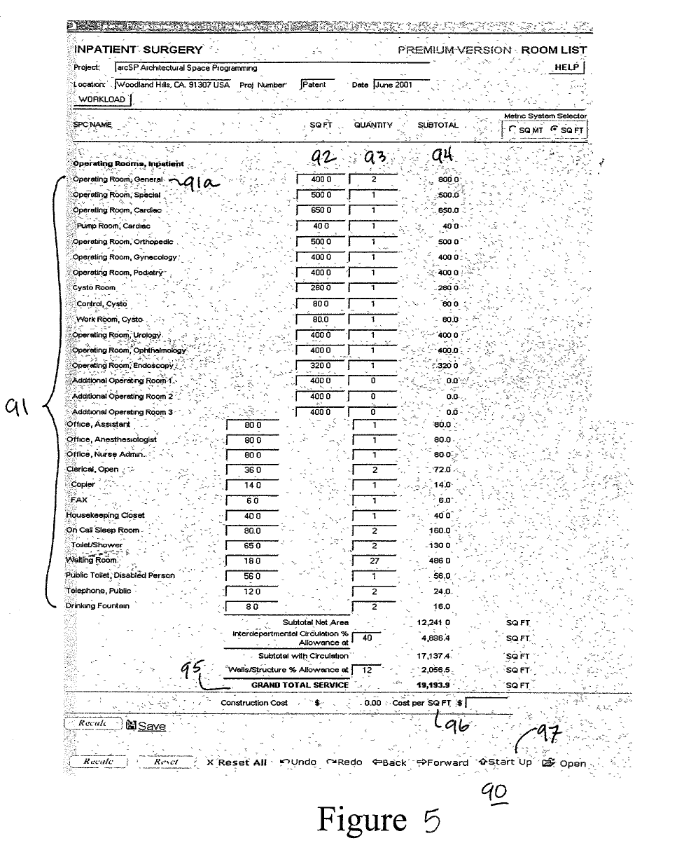

Once the user is satisfied with the data in the Workload Screen 70, a Room List is generated for the department. FIG. 5 is an exemplary Room List 90 for Surgery. The Room List 90, according to the preferred embodiment of the present invention, provides a detailed view of the types of rooms (main workload-driven and support rooms), the number of each type of room, and its suggested size (area). As is seen, each type of room in the department 91, from operating room to waiting room, is listed. For each type of room, e.g., operating room (general) 91a, an area of the room 92 and a quantity of rooms 93 is calculated. Thus, for the operating room (general) 91a, the required minimum area of each operating room is 400 sq. ft., and, based on the workload data, two (2) operating rooms (general) are provided, occupying a total of 800 sq. ft. The room sizes are determined based on industry standards and norms, including equipment and fixtures typically used, for each particular room.

As with most other factors, the user is allowed to adjust the size (area) of any type of room and the number of rooms allotted. The subtotals 94 will be recalculated automatically. As is seen, the Room List 90 provides a comprehensive detailed view of the department. It provides a net area and a grand total area 95 for the department based on grossing (circulation, walls and structure) factors. To calculate a total construction cost for the department, the user can enter a cost based on any type of currency per square feet or meters as selected of area 96.

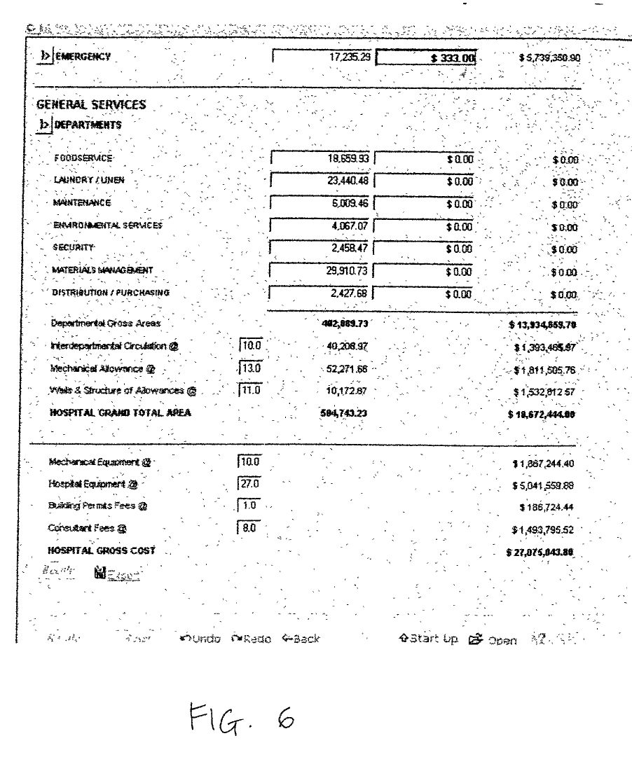

To return to the Control Panel 50 for the project, the user can click on the Start Up button 97. From the Control Panel 50, the user can proceed with architectural space programming another department. In addition, by clicking on a Departmental Totals button 59, an overview of the facility, department-by-department, is provided, as shown in FIG. 6.

Once the user is satisfied with the architectural space programming for the facility, the results may be presented or preserved in any number of ways, including, but not limited to, printing a hardcopy of the result, saving it on the remote server, or saving it on the user's computer system.

As is seen, when the user selects the Healthcare Facility type, a method and system of the present invention guides the user through a set of fields that are specific to the facility type, and specific to the department in the facility. Each different facility type will include tailored fields to reflect the type of facility and/or department. The area calculations take into consideration the different types of equipment that occupy a particular room, their spatial requirements, the occupancy or number of people using the facility, and the workload or activity that takes place in each room along with the time it takes to perform it. To keep pace with changing technology and/or laws, the database is continually updated to track changes in building standards and codes, and new equipment fixtures as they become available. Therefore, the user can be assured that the calculations are up-to-date and accurate.

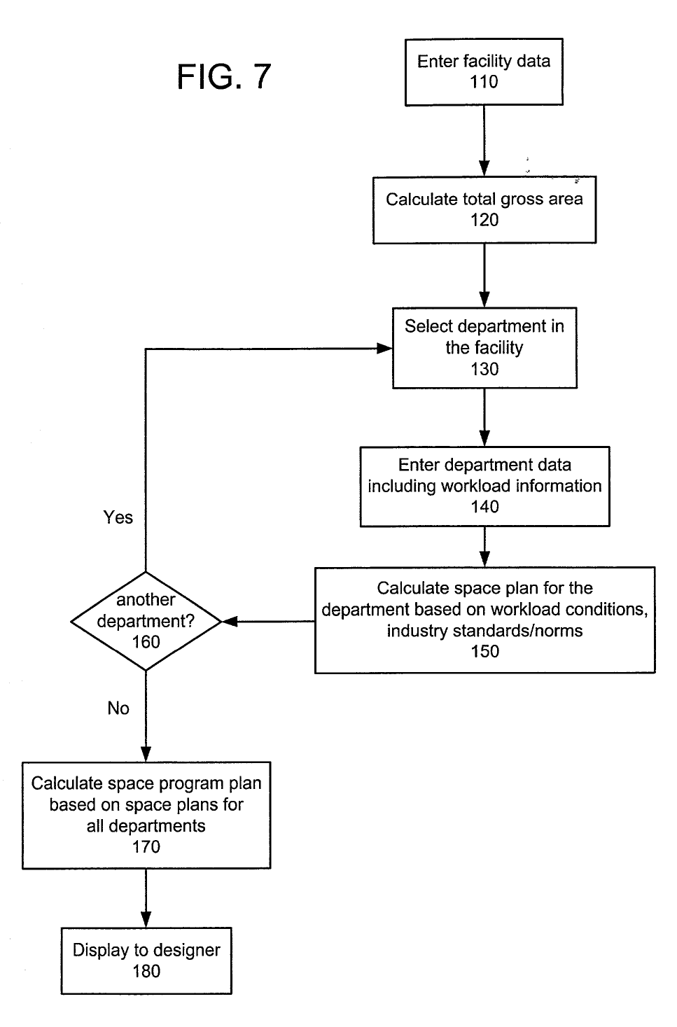

To best illustrate the method in accordance with the preferred embodiment of the present invention, please refer to the flowchart in FIG. 7, which illustrates the architectural space programming process. The process starts by the user entering facility data in step 110. As stated above, facility data relates to information about the facility overall, e.g., the capacity and/or occupancy rates. Next, a total gross area is calculated for the facility in step 120. This calculation is based on the facility data provided by the user, as well as building standards, norms, and codes. In step 130, the user selects a department in the facility to begin detailed architectural space programming. The user enters department data, which includes workload information and utilization factors for the department, via step 140. The department data is then used to calculate a space plan for the department, incorporating building standards, norms and codes in step 150. The space plan includes the number of rooms and types of rooms in the department, as well as the size of each room. Thus, the space plan for the department presents a comprehensive architectural space program for the department.

In step 160, the user is given the option of selecting another department to architecturally space program. The selected department can either be a new or existing department. If new, the user enters department data, as in step 140. If the selected department is an existing department, the user can modify/update the existing department data.

When the user decides not to select another department in step 160, an architectural space program plan is calculated for the facility in step 170. This calculation is based on the space plans for all the departments in the facility. In step 180, the result is presented to the user.

Through the aspects of the present invention, architectural space programming is enhanced and expedited. The user is not required to have any knowledge of building design, or building standards and codes. Rather, the user needs only enter workload and utilization data, presumably information readily available to the user. The present invention automatically processes the project data and performs complex mathematical calculations needed to derive architectural space programming parameters. Because the process is interactive, the user can change the project parameters and evaluate alternate schemes easily and quickly. Thus, a method and system of the present invention provides an automated tool that dramatically decreases the amount of time to calculate a building's size and cost.

Although the present invention has been described in accordance with the embodiments shown, one of ordinary skill in the art will readily recognize that there could be variations to the embodiments and those variations would be within the spirit and scope of the present invention. Thus, for example, although the preferred embodiment of the present invention has been described as an online application, one of ordinary skill in the art would readily appreciate that the present invention can be implemented as a software application running on a processor in a personal computer system. Accordingly, many modifications may be made by one of ordinary skill in the art without departing from the spirit and scope of the appended claims.

What is claimed is:

1. A method for architectural space programming for a facility, wherein the facility includes a plurality of departments, the method comprising the steps of:
a) entering project data, wherein the project data relates to the facility and the plurality of departments; and
b) calculating an architectural space program plan based on the project data.

2. The method of claim 1, wherein the project data includes information related to a cost per unit of space, and the method further comprising the step of:
c) calculating a total construction cost based on the cost per unit of space area.

3. The method of claim 1, wherein the data entering step (a) comprises the step of:
a1) entering facility data, wherein facility data relates to total occupancy and capacity for the facility.

4. The method of claim 3, wherein the calculating step (b) comprises the step of:
b1) calculating a gross area available for use based on the facility data.

5. The method of claim 4, wherein the data entering step (a) further comprises the steps of:
a2) selecting a department in the facility; and
a3) entering department data, wherein department data relates to requirements for the department.

6. The method of claim 5, wherein the calculating step (b) further comprises the step of:
b2) calculating a space plan for the department based on the department data and industry building standards, norms and codes, wherein the space plan for the department includes a number of rooms and a size associated with each room.

7. The method of claim 6, wherein the data entering step (a) further comprises the step of:
a4) repeating steps (a2) and (a3) for each department in the plurality of departments in the facility.

8. The method of claim 7, wherein the calculating step (b) further comprises the step of:
b3) updating the architectural space program plan after a user enters new department data, including modifications to existing department data.

9. The method of claim 5, wherein the department data includes current workload information, utilization information, and projected growth information.

10. The method of claim 8 further comprising the step of:
d) displaying the architectural space program plan and total construction cost to the user.

11. A computer readable medium containing program instructions for architectural space allocation planning for a facility, wherein the facility includes a plurality of departments, the program instructions for:
a) entering project data, wherein the project data relates to the facility and the plurality of departments; and
b) calculating an architectural space program plan based on the project data.

12. The computer readable medium of claim 11, wherein the project data includes information related to a cost per unit of space, and the computer readable medium further comprising the instruction for:
c) calculating a total construction cost based on the cost per unit of space.

13. The computer readable medium of claim 11, wherein the data entering instruction (a) comprises the instruction for:
a1) entering facility data, wherein facility data relates to total occupancy and capacity for the facility.

14. The computer readable medium of claim 13, wherein the calculating instruction (b) comprises the instruction for:
b1) calculating a gross area available for use based on the facility data.

15. The computer readable medium of claim 14, wherein the data entering instruction (a) further comprises the instructions for:
a2) selecting a department in the facility; and
a3) entering department data, wherein department data relates to requirements for the department.

16. The computer readable medium of claim 15, wherein the calculating instruction (b) further comprises the instruction for:
b2) calculating a space plan for the department based on the department data and industry building standards, norms and codes, wherein the space plan for the department includes a number of rooms and a size associated with each room.

17. The computer readable medium of claim 16, wherein the data entering instruction (a) further comprises the instruction for:
a4) repeating instructions (a2) and (a3) for each department in the plurality of departments in the facility.

18. The computer readable medium of claim 17, wherein the calculating instruction (b) further comprises the instruction for:
b3) updating the architectural space program plan after a user enters new department data, including modification to existing department data.

19. The computer readable medium of claim 15, wherein the requirements for the department include current workload information, utilization information, and projected growth information.

20. The computer readable medium of claim 18 further comprising the instruction for:
d) displaying the architectural space program plan and total construction cost to the designer.

21. A system for online architectural space programming for a facility, wherein the facility includes a plurality of departments comprising:
a client computer system for allowing a user to enter project data, wherein the project data relates to the facility and the plurality of departments; and
a server coupled to the client computer system, the server comprising a processing system for calculating an architectural space program plan based on the project data.

22. The system of claim 21, wherein the project data includes information related to a cost per unit of space, and wherein the processor system further for calculating a total construction cost based on the cost per unit of space.

23. The system of claim 21, wherein the client computer system further comprises:
means for entering facility data, wherein facility data relates to total occupancy and capacity for the facility;
means for selecting a department in the facility; and
means for entering department data for the selected department, wherein department data relates to requirements for the selected department.

24. The system of claim 23, wherein the processor system further for:
calculating a gross area available for use based on the facility data; and
calculating a space plan for the selected department based on the department data and industry building standards, norms and codes, wherein the space plan for the selected department includes a number of rooms and a size associated with each room.

25. The system of claim 24, wherein the client computer system further includes means for entering department data for each department of the plurality of departments in the facility.

26. The system of claim 25, wherein the processing system further for updating the architectural space program plan after the entry of department data for a new department.

27. The system of claim 23, wherein department data includes current workload information, utilization information, and projected growth information.

28. The system of claim 26, wherein the client computer system further comprises a display device, and wherein the architectural space program plan is displayed to the user via the display device.

29. A computer system, comprising:
a processing system; and
an application program being executed by the processing system, the application program for receiving project data, wherein the project data relates to a facility and a plurality of departments in the facility, and for calculating an architectural space program plan based on the project data.

30. The computer system of claim 29, wherein the project data includes information related to a cost per unit of space, and wherein the application program further for calculating a total construction cost based on the cost per unit of space.

31. The computer system of claim 29, wherein the project data includes facility data, the facility data relating to total occupancy and capacity for the facility, and department data, the department data relating to requirements for a corresponding department in the plurality of departments.

32. The computer system of claim 31, wherein the application program further for calculating a gross area available for use based on the facility data; and calculating a space plan for each department based on the corresponding department data and industry building standards, norms and codes.

33. The computer system of claim 31, wherein the department data includes current workload information, utilization information, and projected growth information.

34. The computer system of claim 29 further comprising a display device, wherein the architectural space program plan is displayed to a user via the display device.
